(19) United States
(12) Patent Application Publication
(10) Pub. No.: US 2018/0201793 A1
(43) Pub. Date: Jul. 19, 2018

(54) AN AQUEOUS COATING COMPOSITION

(71) Applicant: Rohm and Haas Company, Collegeville, PA (US)

(72) Inventors: Dan Danielle Liu, Shanghai (CN); Tao Wang, Shanghai (CN); Tao Wang, Highton (AU)

(21) Appl. No.: 15/744,864

(22) PCT Filed: Jul. 21, 2015
(86) PCT No.: PCT/CN2015/084604

§ 371 Date: Jan. 15, 2018

(51) Int. Cl. C09D 5/02; C08K 5/5419; C08K 3/22; C08L 33/10; C08L 33/08

(52) U.S. Cl. CPC C09D 5/028; C08K 5/5419; C08K 3/22; C08K 9/04; C08L 33/08; C08K 2003/2241; C08L 33/10

(57) ABSTRACT

The present invention provides an aqueous coating composition comprising by dry weight based on total dry weight of the coating composition, from 2% to 16% a small-particle-size polymeric dispersion of (co)polymeric particles having an average particle size of from 30 to 90 nm, and from 25% to 70% of titanium dioxide particles; from 50% to 100% of the titanium dioxide particles are encapsulated by a polymer shell of (co)polymeric particles.

### FIELD OF THE INVENTION

The present invention relates to an aqueous coating composition which may be used as primer coating or topcoat coating in the architecture coating industry.

### INTRODUCTION

In the architecture coating industry, it usually requires at least two coating layers for operation: a primer coating layer and a topcoat coating layer. The primer coating layer provides the coating film with alkali/efflorescence resistance, while the topcoat coating layer provides opacity. The two-layer system increases complexity of operations and usually requires a longer operation time.

It is therefore desired to provide a one-layer system for coating operation which requires only one coating layer during operation and provides the coating films uncompromised coating performances compared to the two-layer system.

### SUMMARY OF THE INVENTION

The present invention provides an aqueous coating composition comprising, by dry weight based on total dry weight of the coating composition, from 2% to 16% a small-particle-size polymeric dispersion of (co)polymeric particles having an average particle size of from 30 to 90 nm, and from 25% to 70% titanium dioxide particles; and from 50% to 100% of the titanium dioxide particles are encapsulated by a polymer shell of (co)polymeric particles.

### DETAILED DESCRIPTION OF THE INVENTION

As used herein, the term “(co)polymeric” refers to polymeric or co-polymeric.

The present invention provides an aqueous coating composition comprising, by dry weight based on total dry weight of the coating composition, from 2% to 16%, preferably from 3% to 13%, and more preferably from 5% to 10%, a small-particle-size polymeric dispersion of (co)polymeric particles having an average particle size of from 30 to 90 nm, preferably from 40 to 80 nm, and more preferably from 45 to 70 nm; and from 25% to 70%, preferably from 28% to 55%, and more preferably from 30% to 40%, titanium dioxide particles. From 50% to 100%, preferably from 60% to 100%, and more preferably from 70% to 100% by dry weight based on total dry weight of the titanium dioxide particles are encapsulated by a polymer shell of (co)polymeric particles.

Optionally, the aqueous coating composition further comprises a binder component comprising film forming organic (co)polymeric particles.

The (Co)Polymeric Particles

The (co)polymeric particles of the present invention comprise at least one polymerized ethylenically unsaturated nonionic monomer. As used herein, the term “nonionic monomers” refers to monomers that do not bear an ionic charge between pH=1-14. Suitable examples of the ethylenically unsaturated nonionic monomers include alkyl esters of (methyl) acrylic acids such as methyl acrylate, ethyl acrylate, butyl acrylate, 2-ethylhexyl acrylate, decyl acrylate, lauryl acrylate, methyl methacrylate, butyl methacrylate, isodecyl methacrylate, lauryl methacrylate, hydroxyethyl methacrylate, hydroxypropyl methacrylate, and the combinations thereof; (meth)acrylonitrile; (meth)acrylamide; amino-functional and ureido-functional monomers such as hydroxyethyl ethylene urea methacrylate; monomers bearing acetoacetate-functional groups such as acetoacetoxyethyl methacrylate (AAEM); monomers bearing carbonyl-containing groups such as diacetone acrylamide (DAAM); ethylenically unsaturated monomers having a benzene ring such as styrene and substituted styrenes; butadiene; α-olefins such as ethylene, propylene, and 1-decene; vinyl ester of versatic acid; vinyl ester of 2-ethyl hexanoic acid; vinyl monomers such as vinyl chloride and vinylidene chloride; glycidyl (meth)acrylate; and the combinations thereof.

The vinyl ester of versatic acid has the following formula (I):

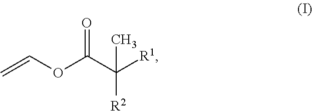

wherein R¹ and R² are each independently C₁-C₁₀ alkyl.

Suitable examples of the vinyl ester of versatic acid include VEOVA™ 10, VEOVA™ 9 commercially available from Momentive Specialty Chemicals.

Preferably, the ethylenically unsaturated nonionic monomers are selected from methyl methacrylate, ethyl acrylate, butyl acrylate, 2-ethylhexyl acrylate, styrene, and the combinations thereof.

The (co)polymeric particles may further comprise less than 10%, preferably less than 5%, and more preferably less than 2.5% by dry weight based on total dry weight of the (co)polymeric particles, a stabilizer monomer. Suitable examples of the stabilizer monomers include sodium styrene sulfonate (SSS), sodium vinyl sulfonate (SVS), 2-acrylamido-2-methylpropanesulfonic acid (AMPS), acrylamide (AM), acrylic acid (AA), methacrylic acid (MAA), and itaconic acid (IA).

The (co)polymeric particles may further comprise from 0.1% to 5%, preferably from 0.3% to 4%, and more preferably from 0.5% to 3% by dry weight based on total dry weight of the (co)polymeric particles, an alkoxysilane. The alkoxysilane may be polymerized on or is cold blended with the (co)polymeric particles, and therefore may be polymerizable or non-polymerizable.

The polymerizable alkoxysilanes are ethylenically unsaturated monomers carrying at least one alkoxysilane functionality. Preferably, the alkoxysilane functionality is hydrolysable. Suitable examples of the polymerizable alkoxysilane include vinyltrialkoxysilane; vinyltrimethoxysilane such as alkylvinyldiakoxysilane; (meth)acryloxyalkyltriakoxysilane such as (meth)acryloxyethyltrimethoxysilane and (meth)acryloxypropyltrimethoxysilane; their derivatives and the combinations thereof.

Suitable Examples of the non-polymerizable alkoxysilane include tris-(trimethoxy)silane; octyl triethoxysilane; methyl triethoxysilane; methyl trimethoxysilane; isocyanate silane such as tris-[3-(trimethoxysilyl)propyl]isocyanurate; gamma-mercaptopropyl trimethoxysilane; bis-(3-[triethoxysilyl]propyl)polysulfide; beta-(3,4-epoxycyclohexyl)-ethyl trimethoxysilane; silanes containing epoxy group (epoxy silane), glycidoxy group and/or glycidoxypropyl group such as gamma-glycidoxypropyl trimethoxysilane, gamma-glycidoxypropyl methyldiethoxysilane, (3-glycidoxypropyl)trimethoxy silane, (3-glycidoxypropyl) hexyltrimethoxy silane, and beta-(3,4-epoxycyclohexyl)-ethyltriethoxysilane.

Preferably, the alkoxysilane is polymerizable.

The small-particle-size polymeric dispersion of (co)polymeric particles has a minimum film forming temperature (MFFT) of from −50 to 80° C., preferably from −35 to 60° C., and more preferably from −20 to 50° C.

The polymer shell of (co)polymeric particles encapsulating the titanium dioxide particles has an MFFT of from −50 to 80° C., preferably from −35 to 60° C., and more preferably from −20 to 50° C.; and an average particle size of from 200 to 800 nm, preferably from 300 to 700 nm, and more preferably from 400 to 600 nm.

The film forming organic (co)polymeric particles of the binder component have an MFFT of from −50 to 100° C.; and an average particle size of from 100 to 500 nm, preferably from 110 to 400 nm, and more preferably from 120 to 300 nm.

Titanium Dioxide Particles

Any titanium dioxide (TiO₂) particles can be used in the coating composition of the present invention. Commercially available titanium dioxide particles include TI-PURE™ R-706 and TI-PURE R-902+ from DuPont. The encapsulation of the polymer shell of (co)polymeric particles on the surface of the titanium dioxide particles can be achieved by polymerization processes. The polymerization processes can be any methods known in the art, including emulsion polymerization, mini-emulsion polymerization, and mechanical dispersing technology.

The Coating Composition

The coating composition may further comprise other pigments or extenders.

As used herein, the term “pigment” refers to a particulate inorganic material which is capable of materially contributing to the opacity or hiding capability of a coating. Pigments typically have a refractive index of equal to or greater than 1.8 and include zinc oxide, zinc sulfide, barium sulfate, and barium carbonate. For the purpose of clarity, titanium dioxide particles of the present invention are not “pigment” of the present invention.

The term “extender” refers to a particulate inorganic materials having a refractive index of less than or equal to 1.8 and greater than 1.3 and include calcium carbonate, aluminium oxide (Al₂O₃), clay, calcium sulfate, aluminosilicate, silicate, zeolite, mica, diatomaceous earth, solid or hollow glass, and ceramic bead. The coating composition may optionally contain solid or hollow polymeric particles having a glass transition temperature (Tg) of greater than 60° C., such polymeric particles are classified as extenders for purposes of pigment volume concentration (PVC) calculations herein. The details of hollow polymeric particles are described in EP 22633, EP 915108, EP 959176, EP 404184, U.S. Pat. No. 5,360,827, WO 00/68304, and US 20100063171. The solid polymeric particles have particle sizes of from 1 to 50 microns, and preferably from 5 to 20 microns. A suitable example of the polymeric particles is ROPAQUE™ Ultra E opaque polymer commercially available from The Dow Chemical Company. For the purpose of clarity, the polymeric particles of the present invention are different from the first or the second polymer of the present invention. Calcium carbonate, clay, mica, and aluminium oxide (Al₂O₃) are preferred extenders.

PVC (pigment volume concentration) of the coating composition is calculated as follows,

PVC (%)=[volume of pigment(s)+volume of extender(s)]/total dry volume of coating.

In a preferred embodiment, the coating composition has a PVC of from 10% to 75%, and preferably from 20% to 50%.

Preparation of the Coating Composition

The preparation of the coating composition can be well-known methods of the art and involves the process of admixing appropriate coating ingredients in the indicated proportions to provide coating as well as the final dry coating film with the desired properties.

Application of the Coating Composition

The coating composition may be applied by conventional application methods such as brushing, roller application, and spraying methods such as air-atomized spray, air-assisted spray, airless spray, high volume low pressure spray, and air-assisted airless spray.

Suitable substrates for coating application include concrete, cement board, medium-density fiberboard (MDF) and particle board, gypsum board, wood, stone, metal, plastics, wall paper and textile, etc. Preferably, all the substrates are pre-primed by waterborne or solvent-borne primers.

### EXAMPLES

### I. Raw Materials

| Abbreviation | Chemical |
|---|---|
| BA | butyl acrylate |
| MMA | methyl methacrylate |
| (M)AA | (methyl)acrylic acid |
| SEM | 2-sulfoethyl methacrylate |
| DMAEMA | 2-(dimethylamino)ethyl methacrylate |
| n-DDM | n-dodecyl mercaptan |
| AIBN | 2,2′-azobis(isobutyronitrile) |
| DS-4 | sodium dodecyl benzene sulfonate |
| EDTA | ethylene diamine tetraacetic acid |
| t-BHP | tert-butyl hydroperoxide |
| SLS | sodium lauryl sulfate |
| SPS | sodium persulfate |
| EUM | ethylene ureaethyl methacrylate |

| Chemical | Supplier |
|---|---|
| FOAMASTER ™ NXZ defoamer | BASF Company |
| TEGO ™ Foamex 825 defoamer | Evonik Industries |
| AMP-95 ™ base | The Dow Chemical Company |
| OROTAN ™ 731A dispersant | The Dow Chemical Company |
| TRITON ™ EF-106 wetting agent | The Dow Chemical Company |
| ACRYSOL ™ SCT-275 | The Dow Chemical Company |
| rheology modifier | |
| ACRYSOL ™ RM-2020 | The Dow Chemical Company |
| rheology modifier | |
| TI-PURE ™ R-706 TiO₂ | DuPont Company |
| OMYACARB ™ 2 extender | Guangfu Building Materials |
| | Group (China) |
| DB-80 extender | Guangfu Building Materials |
| | Group (China) |
| TEXANOL ™ coalescent | The Dow Chemical Company |
| ROPAQUE ™ Ultra E | The Dow Chemical Company |
| opaque polymer | |

### II. Test Procedures

1. Opacity Determination

Drawdown of Coating Compositions was made with a 150 μm Bird Film Applicator™ on a BYKO-chart PA-2810 of BYK-Gardner GmbH, and was then allowed for drying for 1 day in a constant temperature room (CTR). Contrast ratio of dry coating was determined by a BYK-Gardner 6850 Color-Guide Plus Spectrophotometer. Contrast ratio is a test method for the opacity of coating film, Y values of coating film were tested separately in the white chart (Y_{w}) and black chart (Y_{b}). Contrast ratio was defined as Y_{b}/Y_{w}. The higher the contrast ratio, the better the opacity is.

2. Alkali/Efflorescence Resistance

80μ Coating Composition was applied with a brush on one side of a 150 mm×70 mm×4-6 mm fibre reinforced mid-density cement flat panel from Tianjin Weida testing machine factory, and then allowed for drying for 6 days in a CTR. On the 6th day, 0.5 g iron blue solution (20 wt % in 2% polyvinyl alcohol solution) was applied on the surface of the panel with brush and allowed for drying it for another day. The periphery of the panel was covered with wax. The test panels were placed in a container containing 2% sodium hydroxide solution, 5% sodium sulfate solution, and 0.12% calcium hydroxide solution in water. The side applied with the Coating Composition was not dipped into the solutions, while the side without the Coating Composition was dipped into the solutions and had direct contact with the solutions. The panels were removed after exposure for 3 days, and were dried in the CTR for 24 hours and were observed for alkali burn.

Alkali/Efflorescence resistance was evaluated according to the ranking standard described in Table 1.

TABLE 1
Ranking Standard for Alkali Burn Performance

| Alkali/Efflorescence | |
|---|---|
| resistance ranking | Alkali Burn Scale |
| 10 | none |
| 9 | trace |
| 8 | trace to slight |
| 7 | slight |
| 6 | slight to moderate |
| 5 | moderate |
| 4 | moderate to heavy |
| 3 | heavy |
| 2 | heavy to very heavy |
| 1 | very heavy |

### III. Experimental Examples

1. Preparation for the Dispersion of Polymer Shell Encapsulating the Titanium Dioxide Particles (Polymer-TiO₂ Dispersion)

A 250 ml flask equipped with a magnetic stirrer, an N₂-inlet, a reflux condenser, a heating mantel, and a thermocouple was charged with 20 g of SEM, 4 g of DMAEMA, 10 g of BA, 16 g of MMA, 1.1 g of n-DDM, 0.5 g of AIBN, and 100 g of n-propanol. The flask was purged with N2, and heated to 80° C. for 3 hours. The temperature was then raised to 93° C., and 0.25 g of AIBN in 2.0 g n-propanol was added. The temperature was held at 93° C. for 1 hour; then the flask was cooled to room temperature. The product was poured into 100 ml of hexane, and was dried. The dried product was dissolved in sufficient water and NH₃ to make a 21.3% solution at pH 5.0 to prepare a dispersant polymer.

A steel grind pot was charged with 31.7 g of the dispersant polymer and 95.2 g of water. 450 g TI-PURE™ R-706 TiO₂ was added slowly while grinding at 2000 rpm using a Model 50 lab dispersator from Netzsch company equipped with a disk blade. The mixture was ground for 20 min, and then an additional 11.3 g of water was added to make a 76.5% TI-PURE R-706 TiO₂ slurry.

A one gallon four-neck round-bottom flask equipped with a paddle stirrer, an N₂-inlet condenser, a heating mantel, and a thermocouple was charged with 1816 g of the slurry along with a solution of 13.81 g DS-4 (23% solids) in 251.05 g DI water. The flask was purged with N₂, and heated to 30° C. Then 50 g 0.1% iron sulfate and 4 g 1% EDTA were added into the reactor. Two minutes later, co-feed #1 consisting of 2 g t-BHP dissolved in 110.53 g DI water and co-feed #2 consisting of 8.28 g IAA dissolved in 96.25 g DI water were fed to the reactor. Two minutes after the addition of the co-feed solutions, a first monomer emulsion (ME1) prepared previously by mixing 56.52 g DI water, 6.9 g DS-4, and 261.67 g monomers (45.6% BA, 53.4% MMA and 1.0% MAA) was fed to the reactor. Then, a second monomer emulsion (ME2) prepared by mixing 269.5 g DI water, 20.71 g DS-4, and 779.5 g monomers (45.6% BA, 53.4% MMA and 1.0% MAA) was fed to the reactor. Reaction continued for another 20 min. The contents of the reactor were then cooled to room temperature, followed by feeding 84 g NaOH solution (6% solids) in 40 min. Small amounts of gel were filtered by a 100 mesh filter. The remainder was the dispersion of polymer encapsulated titanium dioxide particles. The dispersion comprised 33% titanium dioxide particles, 26% polymer shell of (co)polymeric particles, and water.

2. Preparation for the Small-Particle-Size Polymeric Dispersion of (Co)Polymeric Particles

67.66 g of 28 wt % SLS solution, 4.48 g Na₂CO₃ in 14.71 g DI water and 1052.94 g of DI water were charged to a five-liter multi-neck flask equipped with a mechanical stirrer and were heated to 88° C. under a nitrogen atmosphere. A monomer emulsion was prepared by combining and emulsifying with stirring 583.72 g of BA, 670.94 g of MMA, 12.88 g of MAA, 464.71 g of DI Water, and 9.89 g 28 wt % SLS solution. 44.50 g of the monomer emulsion was added to the flask, and was followed by 2.63 g SPS in 14.74 g DI water. The remaining monomer emulsion and a solution of 1.12 g SPS in 76.47 g DI water were then added to the flask respectively over 75 minutes while the reactor temperature was maintained at 86 to 88° C. During the above process, 25.29 g EUM in 17.65 g DI water was further added over the last 33 minutes. Then, 50 g of DI water was used to rinse the emulsion feed line to the reactor. The reaction mixture was then cooled down to room temperature. During cooling, 0.0038 g of ferrous sulfate mixed with 0.0038 g of EDTA in 3.6 g DI water followed by 0.55 g of t-BHP (70%) and 0.39 g of isoascorbic acid in aqueous solutions were added into the flask. The obtained dispersion was neutralized to a pH of 7.0 to 8.0 with KOH solution. The particle size of this polymeric dispersion is 57 nm as measured by a Brookhaven BI 90 particle size analyzer.

3. Preparation for Film Forming Organic Polymer Binder of (Co)Polymeric Particles

The preparation process of the film forming organic polymer binder of (co)polymeric particles referred to the preparation process for the small-particle-size polymeric dispersion of (co)polymeric particles. The particle size of this polymer binder is 115 nm as measured by a Brookhaven BI 90 particle size analyzer.

4. Preparation of the Aqueous Coating Composition

Comparative Coatings 1 and 2 (Comp. 1 or 2), and Coatings 1, 2, and 3 (Coating 1, 2, or 3) were prepared according to the procedure of Table 2. The Grind ingredients were mixed using a high speed Cowles disperser. The Let-down ingredients were added using a conventional lab mixer.

TABLE 2

| | Coating Compositions | | | | |
|---|---|---|---|---|---|
| | Comp. | Comp. | Coating | Coating | Coating |
| Materials | 1 | 2 | 1 | 2 | 3 |
| | Grind | | | | |
| Water | 80.00 | 62.00 | 62.00 | 62.00 | 62.00 |
| OROTAN 731A | 7.20 | 7.07 | 7.07 | 7.07 | 7.07 |
| dispersant | | | | | |
| TRITON EF-106 | 2.00 | 2.00 | 2.00 | 2.00 | 2.00 |
| wetting agent | | | | | |
| FOAMASTER | 0.40 | 0.40 | 0.40 | 0.40 | 0.40 |
| NXZ defoamer | | | | | |
| TI-PURE R-706 TiO₂ | 160.05 | 0.00 | 0.00 | 40.00 | 80.00 |
| OMYACARB 2 extender | 95.00 | 95.00 | 95.00 | 95.00 | 95.00 |
| DB-80 extender | 55.00 | 55.00 | 55.00 | 55.00 | 55.00 |
| | Let-down | | | | |
| Polymer-TiO₂ Dispersion | 0 | 448.02 | 448.02 | 336.00 | 224.00 |
| water | 120.00 | 0 | 120.00 | 120.00 | 120.00 |
| Film forming organic | 252.20 | 85.40 | 0 | 61.78 | 123.56 |
| polymer binder | | | | | |
| Small-particle-size | 104.32 | 0 | 104.32 | 104.32 | 104.32 |
| polymeric dispersion | | | | | |
| ROPAQUE Ultra E | 50.00 | 50.00 | 50.00 | 50.00 | 50.00 |
| opaque polymer | | | | | |
| TEXANOL coalescent | 25.00 | 25.00 | 25.00 | 25.00 | 25.00 |
| ACRYSOL SCT-275 | 7.32 | 13.02 | 4.05 | 4.32 | 5.78 |
| rheology modifier | | | | | |
| ACRYSOL RM-2020 | 8.34 | 8.92 | 4.17 | 9.92 | 8.18 |
| rheology modifier | | | | | |
| AMP-95 base | 0.18 | 0.22 | 0.74 | 0.17 | 0.17 |
| Water | 32.99 | 147.96 | 22.20 | 27.03 | 37.53 |
| Total | 1000 | 1000 | 1000 | 1000 | 1000 |
| Coating characteristics | | | | | |
| Total PVC | 45% | 45% | 45% | 45% | 45% |

IV. Results

TABLE 3

| | | | | Coating | Coating | Coating |
|---|---|---|---|---|---|---|
| Coatings | | Comp. 1 | Comp. 2 | 1 | 2 | 3 |
| Small-particle-size | | 8.63 | 0 | 8.63 | 8.63 | 8.63 |
| polymeric dispersion (%) | | | | | | |
| TiO₂ particles | Total TiO₂ | 32.36 | 32.36 | 32.36 | 32.36 | 32.36 |
| | dosage (%) | | | | | |
| | Un-encapsulated TiO₂ (%) | 100 | 0 | 0 | 25 | 50 |
| | Encapsulated TiO₂ (%) | 0 | 100 | 100 | 75 | 50 |
| Properties | Contrast ratio | 93.55 | 95.25 | 95.51 | 95.58 | 94.64 |
| | Alkali/efflorescence | 5 | 3 | 9 | 8 | 5 |
| | resistance | | | | | |

% is dry weight percentage based on total dry weight of the coating composition.

As shown in Table 3, Comparative Coating 1 (Comp. 1) comprising small-particle-size polymeric dispersion showed good efflorescence resistance. It is known that the small-particle-size polymeric dispersion provided good penetration into cement, concrete and masonry substrates and thus offered excellent efflorescence resistance. However, it is limited to primer formulation due to stability problem (small-particle-size polymeric dispersion flocculated with un-encapsulated TiO2) and resulted in poor opacity as indicated by contrast ratio compared to Coatings 1, 2 and 3.

Comparative Coating 2 (Comp. 2) comprising polymer shell encapsulated titanium dioxide particles showed good opacity. However, as encapsulation formed bigger particle size, the alkali/efflorescence resistance compromised. Comp. 2 had poorer efflorescence resistance compared to Comp. 1 and Coatings 1, 2, and 3.

The small-particle-size polymeric dispersion and polymer shell encapsulated titanium dioxide particles were combined together in one coating formulation, both its alkali/efflorescence resistance and opacity were improved (Coatings 1, 2 and 3 compared to Comparative Coatings 1 and 2). Specifically, the alkali/efflorescence resistances and opacity performances of Inventive Coatings 1 and 2 were significantly improved. The opacity performance of Coating 3 was also significantly improved, and its alkali/efflorescence resistance performance was well maintained (not hurt).

What is claimed is:

1. An aqueous coating composition comprising by dry weight based on total dry weight of the coating composition, from 2% to 16% a small-particle-size polymeric dispersion of (co)polymeric particles having an average particle size of from 30 to 90 nm, and from 25% to 70% titanium dioxide particles; wherein from 50% to 100% of the titanium dioxide particles are encapsulated by a polymer shell of (co)polymeric particles.

2. The aqueous coating composition according to claim 1, further comprising a binder component comprising film forming organic (co)polymeric particles.

3. The aqueous coating composition according to claim 1 wherein the (co)polymeric particles comprise at least one polymerized ethylenically unsaturated nonionic monomer.

4. The aqueous coating composition according to claim 3 wherein the ethylenically unsaturated nonionic monomers are selected from methyl methacrylate, ethyl acrylate, butyl acrylate, 2-ethylhexyl acrylate, styrene, and the combinations thereof.

5. The aqueous coating composition according to claim 1 wherein the (co)polymeric particles further comprise less than 10% by dry weight based on total dry weight of the (co)polymeric particles a stabilizer monomer.

6. The aqueous coating composition according to claim 5 wherein the stabilizer monomers are selected from sodium styrene sulfonate, sodium vinyl sulfonate, 2-acrylamido-2-methylpropanesulfonic acid, acrylamide, acrylic acid, methacrylic acid, and itaconic acid.

7. The aqueous coating composition according to claim 1 wherein the (co)polymeric particles further comprise from 0.1% to 5% by dry weight based on total dry weight of the (co)polymeric particles an alkoxysilane.

8. The aqueous coating composition according to claim 7 wherein the alkoxysilane is hydrolysable.

9. The aqueous coating composition according to claim 1 wherein the small-particle-size polymeric dispersion of (co)polymeric particles has a minimum film forming temperature of from −50 to 80° C.

10. The aqueous coating composition according to claim 1 wherein the polymer shell of (co)polymeric particles encapsulating the titanium dioxide particles has a minimum film forming temperature of from −50 to 80° C., and an average particle size of from 200 to 800 nm.

11. The aqueous coating composition according to claim 1 wherein the film forming organic (co)polymeric particles of the binder component have a minimum film forming temperature of from −50 to 100° C., and an average particle size of from 100 to 500 nm.
